(19) United States
(12) Patent Application Publication
(10) Pub. No.: US 2007/0157793 A1
(43) Pub. Date: Jul. 12, 2007

(54) Head muting device for percussion instruments, in particular for drums and/or bass drums

(76) Inventor: Peter Ischer, Buchs (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/592,454

(22) PCT Filed: Mar. 21, 2005
(86) PCT No.: PCT/CH05/00166

§ 371 Date: Sep. 7, 2006

(30) Foreign Application Priority Data
Mar. 23, 2004 (CH) 516/04

(51) Int. Cl. G10D 13/02

(52) U.S. Cl. 84/411 M

(57) ABSTRACT

The invention relates to a head muting device (1) for percussion instruments (7), in particular drums (2) and/or bass drums (3). The head muting device (1) comprises at least one muting element (4) and a retaining element (5), which is used to bring the muting element or elements (4) into contact with the head (6). According to the invention, the retaining element (5) is elastic and consists preferably of a cord or a cable (8), in particular a tensioned rubber cable.

The invention relates to a head muting device for percussion instruments, in particular for drums and/or bass drums, according to the preamble to Patent claim 1.

Percussion instruments of this kind are also referred to as rhythm instruments in the music industry. Drums and bass drums are usually equipped with a head muting device, also known as a muting system, in order to influence the vibrations of the head, which produce the tone of the drums and bass drums, in an advantageous manner.

Various head muting devices are already familiar in practice. Instruction for the muting of snares and toms are described in Hugo Pinksterboer, Pocket-Info Drums, Verlag Schott, pp. 84-87. These instructions relate in the first instance to o-ring mutes and to adhesive tapes, which are stuck to the striking side of the head, where appropriate together with a paper handkerchief, in order to reduce the number of overtones. Adhesive tapes of this kind are customarily applied to the edge of the drum head.

Previously disclosed in U.S. Pat. No. 5,763,797 and U.S. Pat. No. 5,892,169 are head muting devices that are applied to the edge of the drum or bass drum in each case by means of clamps. U.S. Pat. No. 5,581,030 describes a head muting device, in which a pad is attached by means of a cord to one of the head tensioning screws and is held against the drum or the bass drum in this way. In the event that no muting is desired, the pad is removed from the head and is allowed to hang to one side next to the drum or bass drum. In the event that muting is desired, the pad is placed on the head.

U.S. Pat. No. 5,892,168 describes a head muting device in which the muting element is of an annular embodiment and is applied, in particular by means of an adhesive, to the rear of the striking side of a drum. Previously disclosed in DE 41 13 515 A1 is a head muting device for a percussion musical instrument, which has a muting device capable of vertical adjustment inside the drum body. The muting device exhibits muting elements that are capable of being brought into contact with the underside of the drum skin. This head muting device has a foot pedal that is attached to the muting device by mechanical means. This head muting device permits the player to produce a muted and unmuted performance in rapid sequence from the percussion musical instrument. Previously disclosed in U.S. Pat. No. 3,453,924 is a head muting device which comprises a head-like overlay that can be placed via its feet on the striking side of a drum or bass drum.

A head muting device of the kind mentioned by way of introduction is previously disclosed, for example, in U.S. Pat. No. 5,233,898. In this head muting device, the muting element is embodied in the form of a fixed cushion, which is securely attached to the inside of a drum via retaining straps and is pressed against the rear side of the drum head. The retaining straps are attached to the inside of the drum, for example by means of tensioning screws.

The object of the invention is to make available a head muting device of the aforementioned kind, which is capable of variable operation.

This object is achieved in accordance with the invention by a head muting device having the characterizing features of Patent claim 1. Advantageous further developments are the subject of the dependent Claims.

In accordance with the invention, the retaining element by means of which the at least one muting element is capable of being brought into contact with the head of the percussion instrument is executed in an elastic fashion. This permits the extremely flexible, and thus variable adjustment of the retaining element and, in particular, of the tension which causes the muting element to be pressed against the head that is to be muted. Universal and continuously variable adjustment of the head muting of drums and/or bass drums with pin-point accuracy is made possible with the help of the elastic retaining element. The muting effect that is achievable with the head muting device in accordance with the invention can thus be capable of extremely variable and flexible adjustment, so that the degree of muting can be influenced with extremely high sensitivity.

According to one particularly preferred further development of the invention, the retaining element is a cord or a cable, preferably a tensioned rubber cable, which cable is preferably held under tension at both ends by means of head tensioning screws, and is preferably tied at its one end to a head tensioning screw and is attached at its other end in an adjustable fashion to a head tensioning screw by means of a cable stopper. A cord or a cable of this kind is readily available in practice, so that the head muting device in accordance with the invention is ultimately embodied without mechanical components. The application or assembly of such a cable is simple and can be readily executed even by unskilled persons. The cable stopper can be a commercially available cable stopper. It is possible to adjust the cable tension in a simple manner with the help of this cable stopper, and in this way to influence the force with which the muting element is applied to the head of the drum or the bass drum. Precise muting of the drum or bass drum in question can thus be achieved with the head muting device in accordance with the invention. In a simplified embodiment, however, it can also be possible to tie both ends of the cable to head tensioning screws. The tension of the cable can also be adjusted in the last-mentioned case by releasing one of the knots and by further tensioning the cable before tying. By the attachment of the cable to the head tensioning screws, the latter exhibit a dual effect, since they serve the purpose not only of tensioning the cable, but also of securing the retaining element, specifically a cord or cable.

According to a further development of the invention, the at least one muting element is secured to the cable, is preferably pulled through asymmetrically by the cable and is held on it in such a way that it is capable of displacement thereon, in particular in a sliding and rotating fashion. In the case of this further embodiment, it is possible to cause the muting element to move from a rest position, in which it is not in contact with the head, and into a working position, in which it is in contact with the head, and vice versa, in conjunction with which such movement of the muting element from one position to the other position may be possible by simple rotation of the muting element through 180° about the cable. The asymmetrical application of the muting element to the cable thus permits, in a simple manner, the rest position in one case, and the muting working position in the other case, to be rotated through 180°. The ability of the muting element to move, and in particular to slide relative to the cable, contributes to a variable ease of handling of the head muting device, since the muting element can be positioned with pin-point accuracy on the head. The desired muting is thus variable and precisely adjustable within wide limits. This means that the at least one muting element is capable of being brought into contact with the head of the percussion instrument by means of the tensioned cable in this way, in conjunction with which, as previously indicated, the tension of the cable and the arrangement of the muting element on the head are adjustable extremely precisely. The distance of the muting element from the edge of the drum or bass drum can be changed by the simple expedient of causing the muting element to slide, as a result of which a different muting effect is achieved. Optimal muting can be imparted to the drum or the bass drum in this way by a simple process of trial and error.

According to one particularly preferred embodiment of the invention, the at least one muting element is a small disc, preferably a felt disc, a larger disc, preferably a cardboard-reinforced disc of foam material, a muting ring, preferably a foam muting ring, and/or a dome-shaped muting element, preferably in the form of a transparent hemisphere. The variable and flexible ease of handling of the head muting device in accordance with the invention is further increased in this way. A corresponding muting element can be selected for every level of muting, in conjunction with which the nature of the muting can also depend on the piece of music, and in particular the style of the music. Muting elements of this kind are easy to install and remove; a head muting device of this kind is extremely simple to operate and vary. In addition, a head muting device of this kind can also be manufactured economically. Moreover, it is possible to combine a plurality of the aforementioned muting elements with one another, because all or several kinds of muting can be used at the same time. The variability of the muting device in accordance with the invention is further improved in this way.

According to another further development of the invention, the muting ring has an L-shaped cross section with two external supporting surfaces of different sizes, in conjunction with which a reinforcing element, in particular a reinforcing film extending parallel to the two supporting surfaces, is preferably arranged between the two supporting surfaces. Different muting effects can be imparted in this way with one and the same muting ring in the sense of a dual effect, depending on which supporting surface of the muting ring comes into contact with the head. A muting ring of this kind contributes to the flexible handling of the head muting device in accordance with the invention.

According to another further development of the invention, the dome-shaped muting element exhibits on the edge of its dome a plurality of muting elements preferably made from a foam rubber material, above which the dome-shaped muting element is capable of being brought into contact with the head. Muting in conjunction with the dome-shaped muting element is capable of being influenced positively with the help of the muting elements. The dome-shaped muting element provides an additional resonance chamber, which can also have a positive effect on the volume of the drum or bass drum. With a dome-shaped muting element of this kind, the effect that can be achieved is similar to that in the case where a central hole is provided in the resonance head of the drum or bass drum. In this respect, the rebound effect that can be achieved from a foot pedal hammer is similar to that in the case in which the aforementioned hole were to be executed in the resonance head.

The dome-shaped muting element can be applied to good effect on the resonance side situated opposite the striking side of a percussion instrument, preferably a bass drum, and preferably exhibits an opening. As already mentioned, the resonance space of the drum or the bass drum can be increased significantly with the help of a dome-shaped muting element of this kind applied in this way, as a consequence of which the effect of the percussion instrument can be influenced and controlled in turn. With the help of the opening, it is possible to insert a microphone into the space enclosed by the dome-shaped muting element. It is possible in this way to record the pure sound of the drum free from disturbing external noises or background noises. The elimination of disturbing noises is thus possible in a particularly simple way.

Embodiments of the subject matter of the invention are explained below in greater detail with reference to the drawing, in conjunction with which all the described and/or graphically represented characterizing features, either individually or in any desired combination, form the object of the present invention regardless of their inclusion in the Patent Claims or their relevance. In the drawing:

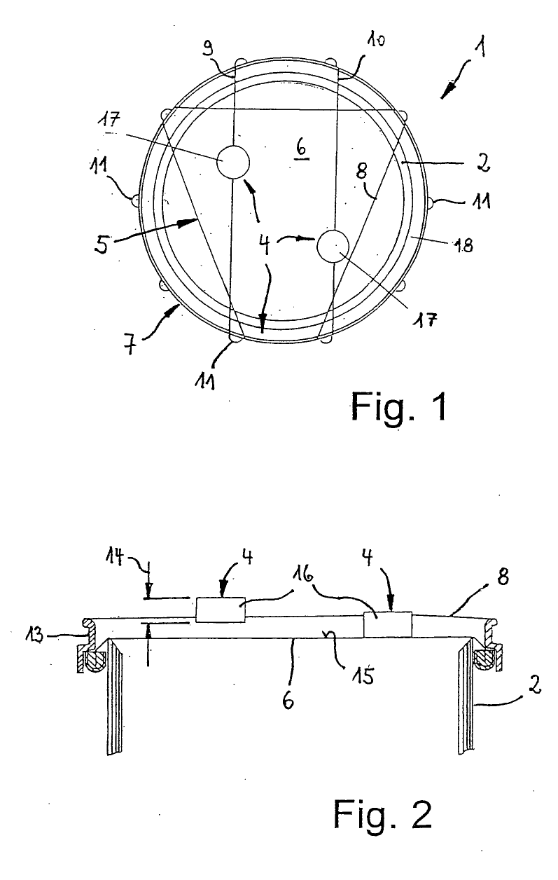

FIG. 1 depicts a schematic representation of a head muting device viewed from above,

FIG. 2 depicts a schematic representation of a partially sectioned representation of a head muting device viewed from the side,

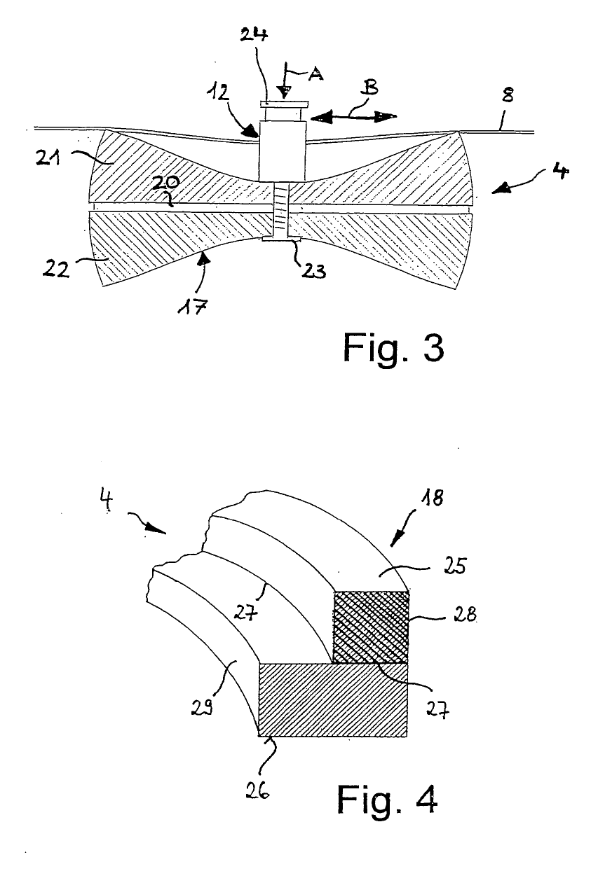

FIG. 3 depicts a schematic representation of a partially sectioned representation of the larger muting element a head muting device viewed from the side,

FIG. 4 depicts a sectioned partial representation of a second muting element of the head muting device as a perspective view,

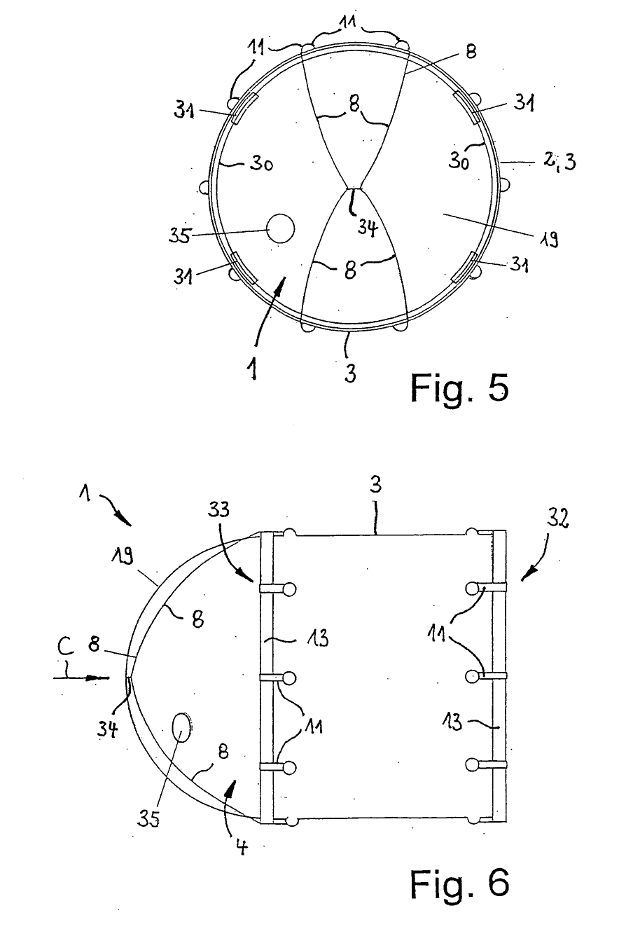

FIG. 5 depicts a schematic representation of a head muting device according to a further embodiment as a view from the front,

FIG. 6 depicts a schematic representation of the head muting device according to FIG. 5 as a side view.

A schematic representation of a head muting device 1 viewed from above is depicted in FIG. 1. The head muting device 1 is intended for percussion instruments, in particular drums 2 and/or bass drums 3. Schematic representations of a drum (or a foot-operated drum) 2 are shown in FIGS. 1 and 2, and of a bass drum 3 in FIGS. 5 and 6. The head muting device 1 has at least one muting element 4 and a retaining element 5, by means of which the at least one muting element 4 is capable of being brought into contact with the head 6 of the percussion instrument 7.

In accordance with the invention, the retaining element 5 is of elastic execution. According to the embodiments depicted in FIGS. 1, 2, 5 and 6, the retaining element 5 is a cord or a cable 8. Preferably, although not exclusively, the retaining device is a tensioned rubber cable.

According to FIGS. 1, 5 and 6, the cable 8 is held under tension at both of its ends 9, 10 via head tensioning screws 11. The head tensioning screws 11 are arranged uniformly distributed around the periphery of the drum 2 or bass drum 3, as illustrated in FIGS. 1 and 5, for example. It is possible to adjust the tension of the head with these head tensioning screws.

According to one particularly preferred embodiment, which is not depicted in greater detail in the Figures, the cable is tied at its one end 9 to a head tensioning screw and is attached at its other end 10 in an adjustable fashion to a head tensioning screw 11 by means of a cable stopper 12. The latter head tensioning screw is preferably not the same screw to which the cable is secured at its end 9. A cable stopper 12 is depicted schematically in FIG. 3 with reference to another embodiment. A cable stopper 12 of this kind can also be executed in such a way that one of the two ends of the cable is attached to a head tensioning screw in an adjustable fashion via the cable stopper. The cable stopper 12 is not illustrated in the representation depicted in FIG. 1.

The at least one muting element 4 is attached to the cable 8, in conjunction with which it is preferably pulled through asymmetrically by the cable and is held on it in such a way that it is capable of displacement thereon, in particular in a sliding and rotating fashion. The asymmetrical arrangement of the cable 8 in relation to the muting element 4 is depicted in greater detail in FIG. 2. Here the cable 8 is held under tension by a clamping collar 13 of the drum 2. The head 6 is situated underneath the cable 8, more or less parallel to the cable. The individual muting elements 4, of which two are depicted in the embodiment illustrated in FIG. 2, are now, as previously mentioned, attached to the cable in a manner in which they are capable of rotating about it. As also mentioned previously, the cable passes through the muting element 4 in each case asymmetrically, that is to say not symmetrically in relation to its height 14. In this way, it is possible to cause the muting element 4 to move from its rest position depicted in the left-hand half of FIG. 2, in which the muting element is not in contact in any way with the head 6, and into the muting working position depicted in the right-hand part of FIG. 2, and vice versa, in conjunction with which, in the muting working position, contact between the muting element 4 and the head is assured. The muting element 4 then makes contact with the upper side 15 of the head and is pressed against the head via the tensioned rubber cable.

The at least one muting element 4 is thus capable, with the help of the tensioned cable 8, of being brought into contact with the head of the percussion instrument 7.

As depicted in FIGS. 1 to 6, the at least one muting element 4 is a small disc 16, for example, preferably a felt disc, a larger disc 17, preferably a cardboard-reinforced disc of foam material, a muting ring 18, preferably a foam muting ring, and/or a dome-shaped muting element 19, preferably in the form of a transparent hemisphere.

In the embodiment of the head muting device depicted in FIG. 1, two aforementioned large discs 17 and a muting ring 18 are used as muting elements 4. In the embodiment depicted in FIG. 2, only two small discs 16 are provided. However, the small discs 16 are preferably, although not exclusively, circular cylindrical discs made of felt, with a diameter in the order of 3.5 cm and a thickness, also referred to as the depth, in the order of 2 cm. The rubber cable 8 is drawn through a disc of this kind, which disc is provided with a hole that is not depicted in greater detail here, which hole, as previously mentioned, is not applied at the centre of its thickness or height 14, but at a slightly higher or lower point in the upper or lower quarter. The fact that the hole is positioned in the upper or lower quarter of the disc offers the possibility of causing this disc to rotate in such a way that it is no longer pressed against the head when in the rest position, but is pressed against the head in the working position. In order to prevent the felt disc from rotating downwards of its own accord from its rest position into its working position, it is expedient to execute the surface of the cable 8 so that it is rougher.

The aforementioned larger disc 17 is depicted in greater detail in a partial view in FIG. 3. This larger disc has a diameter of 10 cm, for example, and a height in the order of 4 cm. It is intended for drums with a greater diameter, for example bass drums. The larger disc 17 is suitable as a general rule for standing drums, in which the head is in a vertical position, for example in the case of foot-operated drums. The drum 2 depicted in FIG. 1 is a foot-operated drum, which can be operated with a foot pedal (not shown). The cable arrangement depicted here would not be suitable for a normal drum, which is played with drumsticks, because the cable arrangement would then prove to be a hindrance for the drum. Sufficient space remains available for a foot pedal, however, in this complicated cable arrangement. The disc depicted in FIG. 1 is thus the larger embodiment 17, because this possess a cable stopper 12. These larger discs 17 are accordingly no longer able to slide down on the vertical cable 8. As already indicated above, the larger disc 17 exhibits a reinforcement 20 made of cardboard, for example. In this respect, the larger disc 17 has an upper half 21 and a lower half 22, between which the reinforcement 20 is located. The larger disc 17 is penetrated more or less centrally by the cable stopper 12, which thus constricts the disc more or less centrally, as indicated in FIG. 3. The lower end of the cable stopper 12 has a rosette 23, which can be connected to the cable stopper 12 via a screw, not illustrated in greater detail. The application of pressure in the direction of the arrow A to the head 24 of the cable stopper 12 enables relative movement of the cable stopper in relation to the cable to take place. The cable stopper 12 is then capable of being displaced, and in particular of being caused to slide, together with the larger disc 17 along the cable 8, that is to say in the direction of the double arrow B. By releasing the head 24, the cable stopper and thus the disc 17 is once again securely attached to the cable; any relative movement between the cable stopper and the disc on the one hand, and the cable on the other hand, is prevented. The cable stopper 12 can also be attached to the disc 17 in such a way that the aforementioned constriction of the disc is eliminated.

It is also possible in the case of this embodiment to cause the disc to rotate about the cable, so that the disc 17 is capable of being brought into contact with the head or moved out of contact with the head, as previously described in relation to the small disc 16 (see FIG. 2). If the foam disc is in its working position, that is to say rotated downwards, muting can be achieved once again as in the case of the small disc 16. Here, too, numerous variations are again possible, in conjunction with which the larger disc 17 can once again be caused to slide on the cable, and the cable can be tensioned to different degrees.

As previously indicated, the muting element 4 can also be a muting ring 18. One part of such a muting ring is depicted as a partially sectioned, perspective view in FIG. 4. According to the embodiment illustrated in FIG. 4, the muting ring 18 has an L-shaped cross section with two external supporting surfaces 25, 26 of different sizes. As also illustrated in FIG. 4, a reinforcing element 27, in particular a reinforcing film extending parallel to the supporting surfaces, is arranged between the two supporting surfaces 25, 26. The reinforcing element 27 serves the purpose of enabling the muting ring 18 in its entirety to be gripped in such a way that it does not collapse, so that the muting ring 18 can be caused to rotate through 180° particularly easily, in order to bring the upper outer supporting surface 25, and no longer the lower outer supporting surface 26 in FIG. 4, into contact with the head.

The muting ring lies on the radial outer edge of the head 6, as indicated in FIG. 1. As also depicted in FIG. 1, this muting element is subjected to loading by the repeatedly tensioned, elastic cable 8 on the outer part of the head 6; the muting ring is thus pressed onto the head from the outside. It is intended in particular for larger drums, such as bass drums or kettle drums.

Individual muting elements can also be combined with one another, as depicted in FIG. 1. The cable 8 in the embodiment of the invention illustrated in FIG. 1 is thus used to receive two large discs 17 and to apply pressure to the muting ring 18. The cable is tensioned repeatedly over the drum 2 for this purpose, as previously mentioned. The working position of the muting ring 18 is conventionally selected in such a way that it is supported on the head with the maximum surface area, that is to say with its supporting surface 26. In the event that not so many overtones are required to be eliminated, however, the muting ring can be rotated in such a way that only its smaller supporting surface, that is to say the supporting surface 25 in FIG. 4, comes to lie on the head. The reinforcing element 27 in this case serves the purpose of increasing the rigidity of the muting ring. The reinforcing element 27, for example, is glued between the annular bodies in the case of gluing together a narrower annular body 28 and a broader annular body 29, so that the annular bodies are connected to one another by the reinforcing element 27.

As previously mentioned, the at least one muting element can also be executed as a dome-shaped muting element 19 in the form of a transparent hemisphere. A dome-shaped muting element of this kind is illustrated in FIGS. 5 and 6, in conjunction with which the view in accordance with FIG. 5 represents a view in the direction of the arrow C according to FIG. 6.

The dome-shaped muting element 19 exhibits on the periphery 30 of its dome at least one muting device 31, which is preferably made from foam rubber. Four such muting devices 31 are illustrated in the embodiment shown in FIG. 5. The dome-shaped muting element 19 is capable of being brought into contact with the head 6 over these muting devices 31. As illustrated in FIG. 6, the dome-shaped muting element 19 is capable of being applied to the resonance side 33 lying opposite the striking side 32 of the percussion instrument 7, preferably a base drum 3. The cable 8 in this case is tensioned over the dome-shaped muting element 19, as shown in FIGS. 5 and 6. To ensure that the two strands of the cable 8 in FIG. 5 do not deviate to the right and to the left, and as such are capable of sliding from the dome-shaped muting element, a thread 34, preferably a nylon thread, is provided more or less in the middle of the strands, with which the two strands of the rubber cable 8 are tied together.

According to a second embodiment of the invention, not illustrated here, it is also possible, in place of the thread 34, to provide grooves in sections on the outer surface of the dome-shaped muting element, into which grooves the strands of the cable 8 can be inserted. In the last-mentioned case, too, the strands of the cable are thus incapable of sliding from the dome-shaped muting element.

The dome-shaped muting element is thus pressed against the head 6 on the resonance side of the instrument with the help of the rubber cable, in conjunction with which the dome-shaped muting element, as previously mentioned, does not have any direct physical contact with the head, but is supported on the head via its muting elements 31. The individual muting elements 31 are not visible in the representation illustrated in FIG. 6, as they are concealed by the clamping collar 13. In a bass drum of this kind, the clamping collar 13 can have a height of 4 cm.

As further indicated in FIGS. 5 and 6, the dome-shaped muting element 19 has an opening 35, via which a microphone, not illustrated here in detail, can be introduced into the interior of the dome-shaped muting element.

With the dome-shaped muting element removed, the elastic cable 8 can be tensioned easily on the appropriate side of the base drum, which in the case of the embodiment depicted in FIG. 6 is the resonance side 33.

According to one embodiment of the invention, which is not depicted in greater detail here, it is also possible to provide the ends 9, 10 of the retaining element 5, for example the ends of the cable 8, with hooks, not depicted in greater detail here, which are capable of being hooked onto the clamping collar 13 or onto the aforementioned head tensioning screws 11. It is also possible to provide only one end of the retaining element with a hook of this kind, and the other end of the retaining element with an aforementioned cable stopper. The use of a cable stopper is associated with the advantage, as previously mentioned, that the cable tension can be varied continuously by moving and/or repositioning the cable stopper. The cable stopper is embodied in such a way that, because of its size, it is unable to pass between the head tensioning screw 11 and the drum or bass drum.

The muting elements 4 arranged as discs 16, 17 are capable of displacement on the cable. If, for example, the muting element is present on the edge of the drum, fewer overtones will be eliminated, so that a smaller muting effect is achieved. If, however, the muting element concerned is moved towards the middle of the head and the tensioned cord is pushed with it, this will mean that more overtones are eliminated, so that a duller tone is ultimately obtained. The cable 8 is not tensioned over the centre of the head, if possible, so that it does not get in the way when drumming. Consequently, the rubber cable should preferably be tensioned along the edge. However, the cable is also applied on the other side in such a way that the muting element concerned can be pushed sufficiently far from the edge onto the head, where this is desirable.

It is clear that extending and stretching the rubber cable results in greater cable tension and an associated higher pressure of the muting element in each case on the head. Higher cable tension causes more complete muting.

As depicted in FIG. 1, the cable can be tensioned cross-wise over the head. This offers the simple possibility of pressing the aforementioned muting ring 18 onto the head. The cable depicted in FIG. 1 is thus a single cable.

In the representation according to FIG. 2, it is not immediately apparent how the rubber cable is secured at its ends. The cable is usually routed over the clamping collar on the right-hand and left-hand sides, and is then tied-off by knotting it to a head tensioning screw, not illustrated in greater detail here, at the bottom on the left-hand side. On the opposing, second or right-hand side, the end is also passed through behind a head tensioning screw and is then provided with the aforementioned cable stopper, so that the end is no longer able to pass behind the head tensioning screw. The cable tension can be varied continuously by sliding the cable stopper at the right-hand end of the rubber cable.

As previously indicated, the individual muting elements can also be varied with one another. It is thus also possible to provide the aforementioned dome-shaped muting element 19 on the resonance side 33 of a bass drum, in conjunction with which a plurality of discs made of a foam material can be installed on the same cable. The muting ring 18 could also be provided in combination with the aforementioned muting discs on the striking side 32 of the bass drum.

It will be appreciated from the foregoing that continuous head muting with pin-point accuracy can be achieved with the head muting device in accordance with the invention. The presence of the muting elements on the cable in a sliding and rotating fashion causes the oscillations of the drum head to be transformed into different oscillations, that is to say the tone of the drums and bass drums can be changed in a desired manner. The muting pressure is varied by stronger or weaker cable tensioning. The dome-shaped muting element not only produces the desired muting, but also has the additional advantage that it increases the volume of the drum kettle. The aforementioned head muting device can be used with all sizes of drum. It is also possible to vary the number of muting elements on the retaining element and the cable, and to select these in line with the wishes of the drummer. The muting elements are also variable in respect of their diameter or their height, or in respect of their material. Rubber, felt, foam materials, sponges, fabrics and other soft materials are particularly suitable as materials for the muting elements.

A head muting device is made available in this way, which is capable of extremely variable use and ease of operation.

1. A head muting device for percussion instruments, in particular drums (2) and/or bass drums (3) having at least one muting element (4) and a retaining element (5), by means of which the at least one muting element (4) is capable of being brought into contact with the head (6) of the percussion instrument (7) characterized in that the retaining element (5) is of elastic execution.

2. A head muting device according to claim 1, characterized in that the retaining element (5) is a cord or a cable (8), and preferably a tensioned rubber cable.

3. A head muting device according to claim 2, characterized in that the cable (8) is held under tension at both ends (9, 10) by means of head tensioning screws (11), and is preferably tied at its one end (9) to a head tensioning screw (11) and is attached at its other end (10) in an adjustable fashion to a head tensioning screw (11) by means of a cable stopper (12).

4. A head muting device according to claims 2 or 3, characterized in that the at least one muting element (4) is secured to the cable (8), is preferably pulled through asymmetrically by the cable (8) and is held on it in such a way that it is capable of displacement on it, in particular in a sliding and rotating fashion.

5. A head muting device according to one of claims 2 to 4, characterized in that the at least one muting element (4) is capable of being brought into contact with the head (6) of the percussion instrument (7) by means of the tensioned cable (8).

6. A head muting device according to one of the foregoing claims, characterized in that the at least one muting element (4) is a small disc (16), preferably a felt disc, a larger disc (17), preferably a cardboard-reinforced disc of foam material, a muting ring (18), preferably a foam muting ring, and/or a dome-shaped muting element (19), preferably in the form of a transparent hemisphere.

7. A head muting device according to claim 6, characterized in that the muting ring (18) has an L-shaped cross section with two external supporting surfaces (25, 26) of different sizes, in conjunction with which a reinforcing element (27), in particular a reinforcing film extending parallel to the two supporting surfaces (25, 26), is preferably arranged between the two supporting surfaces.

8. A head muting device according to claims 6 or 7, characterized in that the dome-shaped muting element (19) exhibits on the edge (30) of its dome at least one muting element (31) preferably made from a foam rubber material, above which the dome-shaped muting element (19) is capable of being brought into contact with the head (6).

9. A head muting device according to one of claims 6 to 8, characterized in that the dome-shaped muting element (19) can be applied on the resonance side (33) situated opposite the striking side (32) of a percussion instrument (7), preferably a bass drum (3), and preferably exhibits an opening (35).
